(19) United States
(12) Patent Application Publication
(10) Pub. No.: US 2008/0164641 A1
(43) Pub. Date: Jul. 10, 2008

(54) Mold for Ceramic Membrane Tube and Fabrication Method of Ceramic Membrane Tube Using the Same

(76) Inventors: Shi-Woo Lee, Daejeon (KR); Doo-Won Seo, Daejeon (KR); Sang-Kuk Woo, Daejeon (KR); Ji-Haeng Yu, Daejeon (KR); In-Sub Han, Daejeon (KR); Ki-Suk Hong, Daejeon (KR)

Correspondence Address: OSTROLENK FABER GERB & SOFFEN, 1180 AVENUE OF THE AMERICAS, NEW YORK, NY, 100368403, US

(21) Appl. No.: 11/909,048

(22) PCT Filed: Dec. 8, 2006
(86) PCT No.: PCT/KR2006/005349

§ 371 Date: Sep. 18, 2007

(30) Foreign Application Priority Data
Dec. 9, 2005 (KR) 10-2005-0120886

(51) Int. Cl. B29C 39/00; B28B 1/00

(52) U.S. Cl. 264/519; 425/405.1

(57) ABSTRACT

An extrusion mold for molding a ceramic membrane having an one-end closed tube structure which is easily integrated and has a high gas separation efficiency, and a fabrication method of a ceramic membrane tube using the same, the extrusion mold comprised of an outer mold, an inner mold and an extrusion hole end cap, wherein the cap has a through hole at its center for controlling an extrusion molding density, and a passage is formed in each of the inner and outer molds for maintaining an inner pressure of an extruded tube to be the same as an outer pressure. The one-end closed ceramic membrane tube is fabricated by supplying a ceramic mixture into the extrusion mold in a state that the end of the extrusion hole of the extrusion mold is closed by the cap, removing the cap after filling the mixture in the end of the extrusion hole, and further supplying the mixture into the extrusion mold to obtain a tubular ceramic extrusion body with a particular length.

### TECHNICAL FIELD

The present invention relates to a mold for a ceramic membrane tube and a fabrication method of the ceramic membrane tube using the same, and more particularly, to a fabrication method of a ceramic membrane which is easily integrated, supports a high gas separation efficiency, and has a structure of a tube closed at one end, and an extrusion mold therefor.

### BACKGROUND ART

Multicomponent ceramic membrane denotes a separation membrane which has a dense structure with more than 90 percent of relative density and also has a function of selectively permeating and separating desired gases using an ionic diffusion by an electrochemical driving force at temperature higher than about 500° C. For spontaneously and continuously diffusing the ion, electrical neutrality should be maintained, which must come with electronic movement. Therefore, the dense ceramic membrane spontaneously has a mixed ionic-electronic conductivity or is composed of a composite structure of ionic conductor with electronic conductor. Here, pure gaseous elements which can be separated may include oxygen, hydrogen and carbon dioxide.

Perovskite type oxide or pyrochlore type oxide each having a composition of La₁₋ₓAₓB′_{1-y}B″_{y}O_{3-δ} is used as a dense oxygen membrane which can separate pure oxygen (here, regarding La₁₋ₓAₓB′_{1-y}B″_{y}O_{3-δ}, A is a cation such as Ba or Sr, B′ and B″ are cations such as Mn, Fe, Co, Ni, Cu, Al, Ga or Ge, x is in a range of 0.05 to 1.0, and y is in a range of 0 to 1.0). Fluorite type oxide such as zirconia or ceria having trivalent cation partially substituted is also used.

Perovskite type oxide having a composition of ABO_{3-δ}, in which a small quantity of cation (e.g., Y, Yb, Eu or Gd) is added, is used as a dense hydrogen membrane which can separate pure hydrogen (here, regarding ABO_{3-δ}, A is a cation such as Ba or Sr, B is a cation such as Ce, Zr or Ti). Membrane structure including a supporter and salts composed of lithium carbonate, potassium carbonate or sodium carbonate is used as a carbon dioxide membrane which can separate pure carbon dioxide.

The ceramic membranes must be integrated together in order to separate a great quantity of gas. A single ceramic membrane used for the integration is prepared in a planar shape or a tubular shape. The planar membrane is easy to be formed and to be integrated, whereas difficult to have a larger area. Furthermore, an area required to be sealed at high temperature is widened, which may result in leakage of gas.

On the other hand, the tubular membrane is structurally stabilized, formed to have a large area and easily sealed, whereas difficult to be formed and to integrate unit membranes.

In the meantime, of several tubular structures, an one-end closed tube structure closed at one end has advantages of the tubular membrane structure and also supports a high usage efficiency of injected gas. In addition, the one-end closed tube structure is not stressed by a thermal expansion at high temperature, and is only required to seal the other end opened.

FIG. 1 is a mimetic diagram showing a structure of an one-end closed tubular membrane 10.

A membrane is formed such that a tube body 12 is integrally formed with an end cap 14 connected to the end of the tube body 12. During a gas separation process, a gas injection pipe 20 having a passage therein is inserted into the membrane. For the gas supplied through the injection pipe 20 (e.g., a gas mixture of nitrogen with oxygen), when the gas is bumped against the membrane, the oxygen is diffused in an ion state to pass through the membrane, while the nitrogen can not pass through the membrane to thereby be escaped to the outside. As such, in the gas separation process, dense structure of the membrane and non-existence of pore prevent gas leakage and increase gas separation efficiency.

An end of the membrane, i.e., a closed end portion of a cylindrical tube is formed by attaching a typical tube thereto. Korean Patent Application (Laid Open) No. 2001-42562 proposes an one-end closed tube structure which is applied to a cathode of solid oxide fuel cells (SOFC). This structure forms a coupling joint by connecting a cap to an end of the cathode tube for a ceramic fuel cell, to thereafter heat and sinter the formed structure, thereby achieving the complete cathode tube.

However, the one-end closed tube structure should use an organic compound to bond the cap and the tube body in order to close one end of the tube, which makes it difficult to obtain a dense sintered structure that gas leakage can be prevented at the bonded surface, even if the bonded surface is heat-treated later. That is, the problem in the tubular membrane shown in FIG. 1 is that unexpected pore is formed or any defect is caused at a portion A in the drawing.

Therefore, the tube structure and the fabrication method thereof may be applied to the cathode tube for the ceramic fuel cell, but be difficult to be applied to the ceramic membrane having a dense structure related to the present invention.

### DISCLOSURE OF THE INVENTION

Therefore, it is an object of the present invention to fabricate an extrusion mold for an one-end closed ceramic membrane tube which has dense fine structure and has no pore or defect.

It is another object of the present invention to fabricate an one-end closed ceramic membrane tube through simple effective processes without any defect.

To achieve these objects, there is provided an extrusion mold for a ceramic membrane tube in accordance with one aspect of the present invention comprising: an outer mold having a cylindrical inner space and opened front/rear ends; an extrusion hole end cap coupled to the front end of the outer mold and having a through hole connected to the outside; and an inner mold including a first cylindrical member disposed in the inner space of the outer mold and spaced apart from an inner side of the extrusion hole end cap so as to have an outer diameter smaller than an inner diameter of the outer mold, and a second cylindrical member having an outer diameter which is the same as the inner diameter of the outer mold.

A through hole is formed in one side of the outer mold, and an inner passage which is inwardly formed through the inner mold in a length direction thereof to be extended to one side of the second member, wherein the inner passage is connected to the through hole formed in the outer mold.

In another embodiment of the present invention, a fabrication method of an one-end closed ceramic membrane tube comprises: attaching a cap to an end of an extrusion hold of an extrusion mold, the extrusion mold including an outer mold and an inner mold; supplying a ceramic membrane mixture into a space between the outer mold and the inner mold of the extrusion mold to perform an extrusion; removing the cap when the ceramic membrane mixture is filled in the end of the extrusion hole to create a closed structure; and obtaining an extrusion body with a particular length by additionally supplying the ceramic membrane mixture into the space between the outer and inner molds of the extrusion mold and then continuously performing the extrusion.

In another embodiment of the present invention, a fabrication method of an one-end closed ceramic membrane tube comprises: attaching a cap to an end of an extrusion hold of an extrusion mold, the extrusion mold including an outer mold and an inner mold; supplying a ceramic membrane mixture into a space between the outer mold and the inner mold of the extrusion mold to perform an extrusion; removing the cap when the ceramic membrane mixture is filled in the end of the extrusion hole to create a closed structure; obtaining a ceramic extrusion body with a particular length by additionally supplying the ceramic membrane mixture into the space between the outer and inner molds of the extrusion mold and then continuously performing the extrusion; and coating a ceramic membrane mixture which is the same as or different from the ceramic membrane mixture onto the surface of the extrusion body.

### EFFECT OF THE INVENTION

The present invention can fabricate a one-end closed ceramic membrane tube which has a dense structure without any pore or defect.

Particularly, the present invention can control an extrusion molding density in a process of extruding the ceramic membrane tube and facilitate a mass production of a uniform tube structure through a consecutive process.

### BRIEF DESCRIPTION OF THE DRAWINGS

FIG. 1 is a mimetic diagram showing structure and operation of a tube-type ceramic gas membrane;

FIGS. 2 and 3 are a perspective view and a sectional view, each showing an outer mold of an extrusion mold according to the present invention;

FIGS. 4 to 6 are a perspective view and a sectional view, each showing a cylindrical cap mounted in an end of an extrusion hole of an extrusion mold according to the present invention;

FIGS. 7 to 9 are a perspective view, a sectional view and a perspective view shown based on another side, each showing an inner mold of an extrusion mold according to the present invention;

FIG. 10 is a sectional view showing an extrusion mold according to the present invention having each component coupled thereto;

FIG. 11 is a perspective view showing an one-end closed ceramic membrane tube fabricated by coating a ceramic supporter having a plane portion closed at one end, with a ceramic membrane thick film;

FIG. 12 is a perspective view showing a ceramic supporter tube having a hemi-spherical portion closed at one end; and

FIG. 13 is a perspective view showing a gas separation module fabricated by integrating four one-end closed ceramic membrane tubes together.

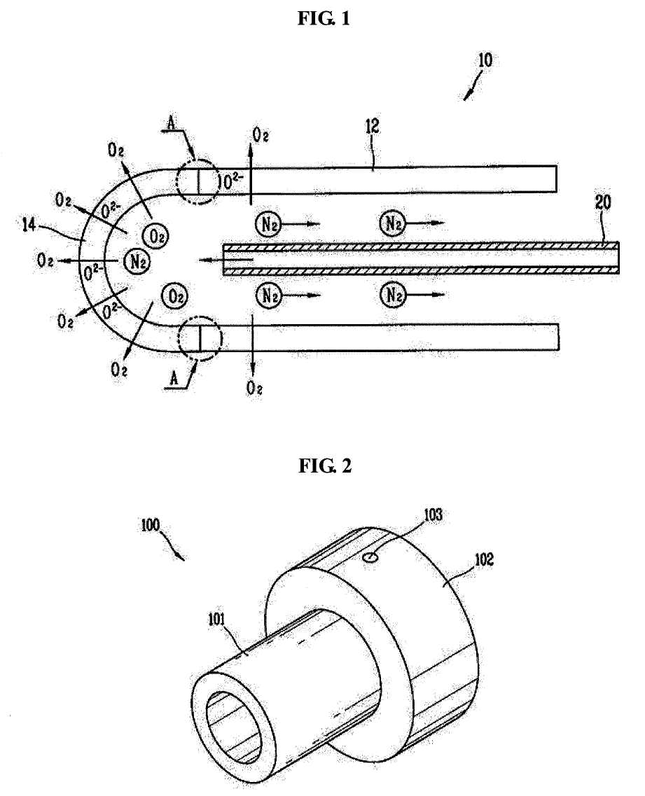

### MODES FOR CARRYING OUT THE PREFERRED EMBODIMENTS

An extrusion mold used for fabricating an one-end closed ceramic membrane tube according to the present invention may roughly be divided into three portions.

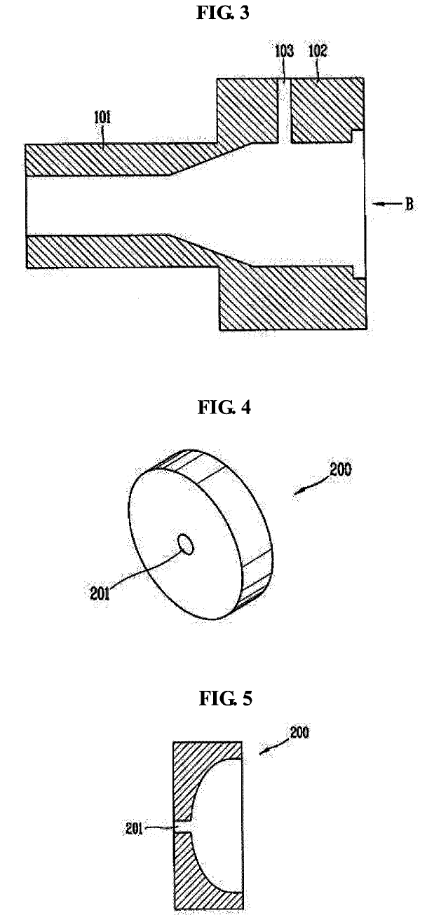

FIGS. 2 and 3 show a cylindrical outer mold 100 which is a first element configuring the extrusion mold. The outer mold 100 has both ends opened and is formed in a hollow cylindrical shape. A front portion 101 of the outer mold 100 corresponds to an extrusion hole, and denotes a portion connected to an end cap in an extrusion process. A rear portion 102 of the outer mold 100 has a different size from that of the front portion 101. However, it may not be limited to this. A through hole 103 for connecting inside of the outer mold 100 and outside thereof is formed in one side of the rear portion 102. The through hole 103 is connected to a part of an inner mold to be explained later so as to equally maintain an inner pressure and an outer pressure of the extrusion mold during the extrusion process.

A non-heat-treated mixture of ceramic powder which is the material of the ceramic membrane, solvent and binder all mixed at a particular ratio is put into an end of the rear portion 102 in a direction B.

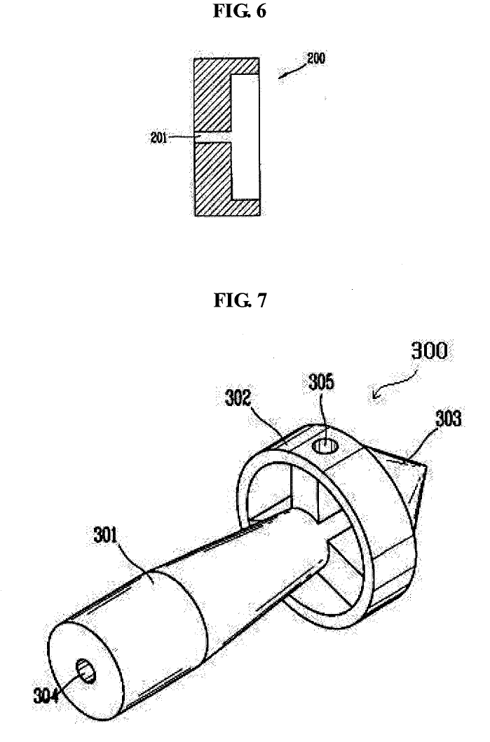

FIGS. 4 to 6 mimetically show an extrusion hole end cap 200 (located at the end of the extrusion hole), which is a second element of the extrusion mold. The cap 200 is coupled to the extrusion hole of the extrusion mold, namely, the end of the front portion 101 of the outer mold 100 so as to close one end of the extrusion mold. Therefore, the ceramic membrane tube fabricated by the extrusion process can be fabricated in a structure closed at one end. A through hole 201 is formed through the center of the cap 200. The through hole 201 serves to adjust an extrusion molding pressure applied to a ceramic membrane mixture having one end extruded with being closed by the extrusion mold. The extrusion molding pressure will be described later in more detail in conjunction with a fabrication method. The extrusion hole end cap 200 can be coupled to the front end 101 of the outer mold 100 in various manner. For example, a coupling unit such as a bolt may be used for the coupling, and also a coupling using screws may be available by respectively forming screw threads at an inner circumferential surface of the cap 200 and an outer circumferential surface of the front portion 101 of the outer mold 100.

The inner circumferential surface of the extrusion hole end cap 200, i.e., the surface corresponding to an inner end of the extrusion mold may be formed in a hemi-circular shape (shown in FIG. 5) or a plane shape (shown in FIG. 6).

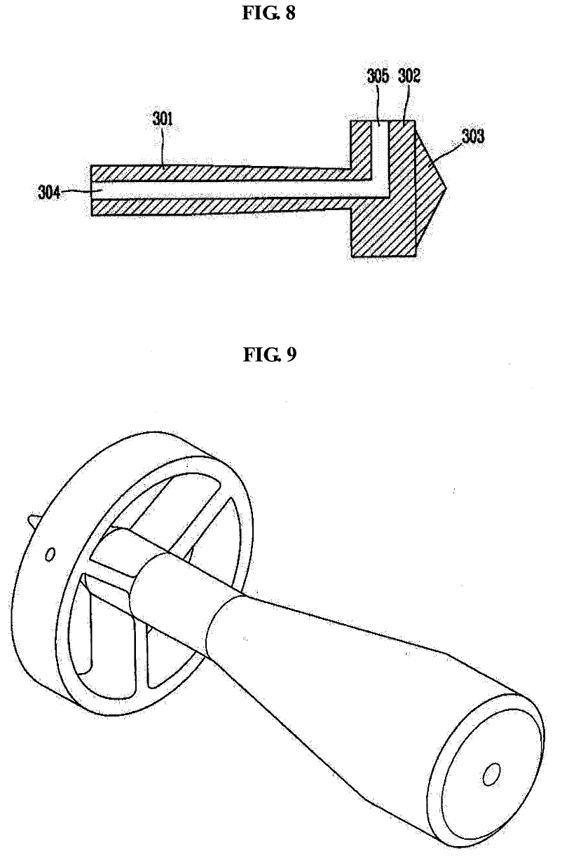

FIGS. 7 to 9 show a cylindrical inner mold 300 inserted into the outer mold, which is a third element of the extrusion mold. The inner mold 300 includes a cylindrical first member 301 coupled to the outer mold 100 with being spaced apart from an inner circumferential surface of the outer mold 100 by a certain gap, so as to obtain an extrusion body with a certain thickness (i.e., the first member 301 has an outer diameter smaller than an inner diameter of the outer mold 100), and a second member 302 having the same outer diameter as the inner diameter of the outer mold 100 so as to allow the inner mold 300 to be firmly coupled to the inside of the outer mold 100. The second member 302 has a passage therein such that an extrusion mixture can be filled in the extrusion mold, as shown in FIGS. 7 and 9.

An inner passage 304 is formed in the center of the inner mold 300 from one end of the first member 301 in a length direction of the first member 301. This inner passage 304 is extended up to an outer hole 305 which is exposed at a certain portion on the outer circumferential surface of the second member 302. The passage 304 connects the inside of the extrusion mode to the outside thereof. The passage 304 also serves to maintain the inner pressure of the extrusion body to be the same as the outer pressure of the extrusion mold, thereby preventing the extrusion body from being recessed due to a low pressure inside the extrusion body when forming the cylindrical extrusion body during the extrusion process.

A protrusion 303 having a conical shape is formed at an end of the second member 302 of the inner mold 300. The protrusion 303 corresponds to an inlet which the extrusion mixture is put into, and facilitates the combining of the mixture. Preferably, the protrusion 303 has the conical structure supported by three parts of the second member 302 in order to affect the flow of the mixture as little as possible.

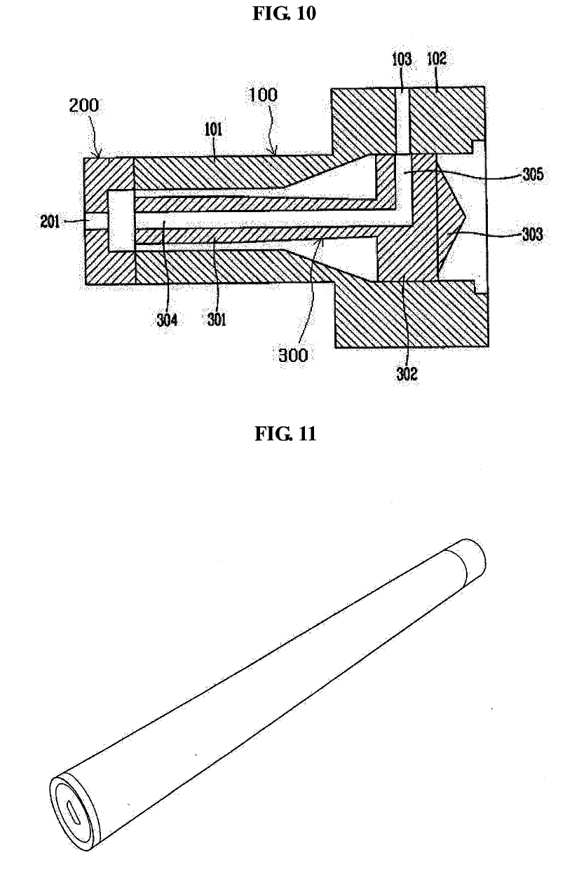

FIG. 10 shows a coupled state of each of the outer and inner molds 100 and 300 and the cap 200 explained above. The inner mold 300 is inserted into an inner space of the outer mold 100 to be fixed thereto. The inner circumferential surface of the outer mold 100 is spaced apart from the outer circumferential surface of the inner mold 300 by a certain interval (gap) so as to allow the extrusion body to be extruded with a particular thickness. The cap 200 is coupled to one end of the outer mold 100, namely, the end of the extrusion hole, thus to obtain a structure closed at the one end during the extrusion process.

With reference to the extrusion mold shown in FIG. 10, a fabrication method of a one-end closed ceramic membrane tube according to the present invention will be described.

First, as shown in the drawing, in a state that one end of the extrusion hole is closed by the cap 200, a mixture of ceramic for ceramic membrane with organic compound is put into an end of the outer mold 100, namely, an end of the second member 302 of the inner mold 300 by using an appropriate extrusion pressure. The mixture having put into the end of the outer mold 100 moves (flows) in a space between the outer mold 100 and the inner mold 300 and thusly forms a lateral wall of the tube. The mixture reaching the end of the extrusion hole, i.e., the end of the front portion 101 of the outer mold 100 contacts the inner circumferential surface of the cap 200 to thusly form a closed structure. As such, adapting the mechanism aforementioned, the one-end closed ceramic membrane tube according to the present invention is fabricated, without any separate bonding process performed, such that a tube body is integrally formed with the tube end. Therefore, the finally obtained tube can prevent the gas leakage from occurring at its end due to an undesired pore.

After forming the structure of the extrusion body closed at one end, the extrusion hole end cap 200 is removed and the extrusion process is continuously performed to create the tube body with a particular length. In this case, if the inner space of the extrusion hole end cap 200 is blocked from the outside, a time point when the extruded mixture forms a closed structure is not recognized and also a pressure applied to the mixture is increased due to the continuous extrusion. Therefore, a molding density of the completely-obtained tube-shaped extrusion can neither be controlled, nor uniformly secured at each portion of the tube.

The present invention provides the through hole 201 formed through the center of the cap 200 to the exterior, and accordingly the extrusion molding density can be controlled. Immediately after the mixture is extruded to the outside through the through hole 201 of the cap 200 while the extrusion process is in progress, the extrusion process is stopped and the cap 200 is removed. The use of a cap having a through hole with a different size can control the molding density of the mixture forming the tube. The closed end of the extrusion body may have a plane shape or a hemispherical shape depending on the shape of the inner circumferential surface of the extrusion hole end cap 200. Also, the closed end of the extrusion may be formed in a different shape by changing the shape of the cap 200.

The extrusion process of the ceramic membrane mixture is continuously performed until the tube has a desired length. In this process, if the inside of the tube being formed is blocked from outer air, the inside of the tube becomes a vacuum state due to the continuous extrusion, which causes the tube to be recessed. The present invention provides the passage 304, which is formed in the inner mold 300 in its length direction to be extended to one side of its rear end of the inner mold 300, and then connects the passage 304 to the through hole 103 of the outer mold 100, such that an inner pressure of the cylindrical extrusion body is the same as the air pressure during the extrusion process. Hence, the tube formed by the extrusion process can be evenly formed without being recessed.

The extrusion body having desired length and shape is heat-treated. First, the extrusion body is heat-treated at temperature below 900° C. to volatilize or debind the solvent and organic additive contained in the mixture, and thereafter is heat-treated at temperature of 1000 to 1550° C., thus to be sintered.

Based on a Wagner equation, a gas flow rate of the ceramic membrane linearly increases as the thickness of the ceramic membrane decreases. Therefore, in order to obtain a higher gas flow rate, the ceramic membrane which is unfragile and dense should be fabricated to be thinner. For this, it is preferable to coat a supporter having a porous structure with the ceramic membrane in a shape of a thick film.

The fabrication method of the one-end closed ceramic membrane tube according to the present invention may also be applied to a fabrication of a porous ceramic membrane supporter, so as to enable fabrication of a ceramic membrane which secures a high gas flow rate. That is, according to the fabrication method according to the present invention, the porous tubular ceramic membrane supporter is created, and then dense ceramic membrane is coated onto the surface of the supporter.

Here, the ceramic composing the porous tube supporter may be a material having no characteristic feature of gas separation, be substantially the same as or similar to the material of the ceramic membrane, or be a material having the characteristic feature of the gas separation.

The porous tubular ceramic supporter is created by adapting the same processes as aforementioned. First, components of the extrusion mold are coupled to one another. In the state that one end of the extrusion hole is blocked by the cap 200, a mixture of ceramic for supporter with organic additive is put into the extrusion mold by using a particular extrusion pressure. A lateral wall of a tube is thusly formed along a space between the outer mold 100 and the inner mold 300. The mixture reaching the extrusion hole then creates a closed structure by arriving at an inner circumferential surface of the cap 200.

Thereafter, the cap 200 is removed immediately after the mixture is extruded to the outside through the through hole 201 of the cap 200. An additional amount of the mixture for the ceramic supporter is re-extruded to form a lateral wall of a tube extrusion body with a desired length.

The surface of the finally-obtained tubular ceramic supporter is coated with a ceramic membrane mixture.

For the coating, dipping or tape casting using the mixture of the ceramic with the organic compound composing the ceramic membrane may be used.

The coating process may be performed after extruding and drying the supporter or be performed after the supporter extrusion body is heat-treated at temperature below 900° C. to debind the organic additive contained in the mixture, and then the supporter extrusion body is heat-treated again at temperature higher than 900° C. to increase cohesion between ceramic particles.

The ceramic tube supporter coated onto the surface of the ceramic membrane mixture is sintered by being heat-treated at temperature of 1000° C. to 1550° C.

The ceramic membrane tube obtained by the series of processes aforementioned was shown in FIGS. 11 through 13.

FIG. 11 shows an one-end closed ceramic membrane tube fabricated through the series of processes according to the present invention, which shows an one-end closed ceramic membrane tube obtained by coating an oxygen membrane thick film having a composition of La_{0.6}Sr_{0.4}CoO₃ onto a magnesia based ceramic supporter having a plane part closed at one end.

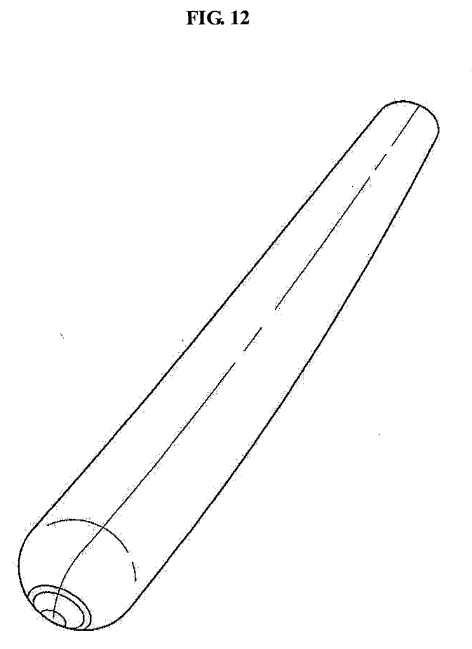

FIG. 12 shows an one-end closed ceramic membrane tube fabricated through the series of processes provided by the present invention, which shows a magnesia based ceramic supporter tube having a hemispherical part closed at one end.

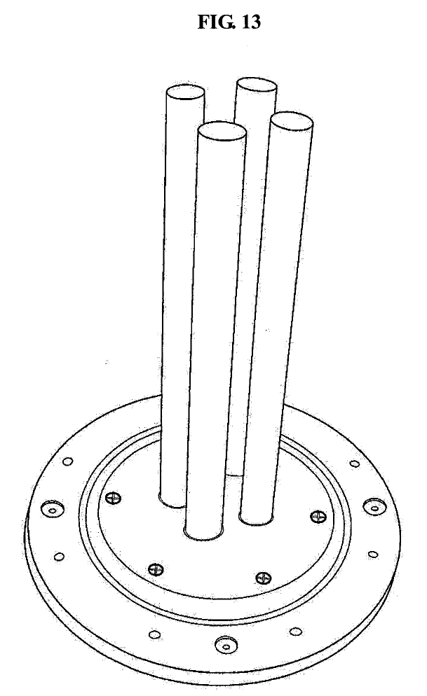

FIG. 13 shows a gas separation module, which is fabricated by integrating four one-end closed ceramic membrane tubes fabricated by coating a ceramic membrane thick film onto a ceramic supporter having a plane closed structure for heat-treatment.

The one-end closed ceramic membrane tube fabricated according to the present invention has a great gas reaction area, has no thermal stress because thermal expansion of the ceramic membrane is not restricted at high temperature. The one-end closed ceramic membrane tube can easily prevent gas leakage by sealing one end of an opened structure at a room temperature.

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. An extrusion module for a ceramic membrane tube comprising:
an outer mold having a cylindrical inner space and opened front/rear ends;
an extrusion hole end cap coupled to the front end of the outer mold and having a through hole connected to the outside; and
an inner mold including a first cylindrical member disposed in the inner space of the outer mold and spaced apart from an inner side of the extrusion hole end cap so as to have an outer diameter smaller than an inner diameter of the outer mold, and a second cylindrical member having an outer diameter which is the same as the inner diameter of the outer mold.

2. The extrusion mold of claim 1, wherein the inner shape of the extrusion hole end cap is planar.

3. The extrusion mold of claim 1, wherein the inner shape of the extrusion hole end cap is hemi-spherical.

4. The extrusion mold of claim 1, wherein a through hole is formed in one side of the outer mold, and an inner passage which is inwardly formed through the inner mold in a length direction thereof to be extended to one side of the second member, wherein the inner passage is connected to the through hole formed in the outer mold.

5. The extrusion mold of claim 1, wherein the end of the second member of the inner mold is conical.

6. A fabrication method of a one-end closed ceramic membrane tube comprising:
attaching a cap, which has a through hole at the center thereof, to an end of an extrusion hold of an extrusion mold, the extrusion mold including an outer mold and an inner mold;
supplying a ceramic membrane mixture into a space between the outer mold and the inner mold of the extrusion mold to perform an extrusion;
removing the cap when the ceramic membrane mixture is extruded through the through hole; and
obtaining an extrusion body with a particular length by additionally supplying the ceramic membrane mixture into the space between the outer and inner molds of the extrusion mold and then continuously performing the extrusion.

7. (canceled)

8. The method of claim 6, wherein the size of the through hole formed in the cap is adjusted to control a molding density of the ceramic membrane mixture.

9. The method of claim 6, wherein an inner pressure of the extrusion mold is maintained to be equal to an outer pressure.

10. The method of claim 6, further heat-treating the extrusion body.

11. A fabrication method of a one-end closed ceramic membrane tube comprising:
blocking (closing) an end of an extrusion hold of an extrusion mold by using a cap, the extrusion mold including an outer mold and an inner mold;
supplying a ceramic membrane mixture into a space between the outer mold and the inner mold of the extrusion mold to perform an extrusion;
removing the cap when the ceramic membrane mixture is filled in the end of the extrusion hole to create a closed structure;
obtaining a ceramic extrusion body with a particular length by additionally supplying the ceramic membrane mixture into the space between the outer and inner molds of the extrusion mold and then continuously performing the extrusion; and
coating a ceramic membrane mixture which is the same as or different from the ceramic membrane mixture onto the surface of the extrusion body.

12. The method of claim 11, further comprising heat-treating the extrusion body.

13. The method of claim 13, wherein the cap has a through hole at the center thereof, and the cap is removed from the extrusion mold when the ceramic membrane mixture is extruded through the through hole in the extrusion process.

14. The method of claim 13, wherein the size of the through hole formed in the cap is adjusted to control a molding density of the ceramic membrane mixture.

15. The method of claim 11, wherein an inner pressure of the extrusion mold is maintained to be equal to an outer pressure.

16. The method of claim 11, wherein the ceramic membrane mixture is coated in a dipping manner.

17. The method of claim 11, wherein the ceramic membrane mixture is coated using a tape dried after casting.
